(19) United States
(12) Patent Application Publication
(10) Pub. No.: US 2012/0236211 A1
(43) Pub. Date: Sep. 20, 2012

(54) Display, Information Transmission Method and Information Communication System

(75) Inventor: Hideyuki Hagino, Kumagaya-Shi (JP)

(73) Assignee: Kabushiki Kaisha Toshiba, Tokyo (JP)

(21) Appl. No.: 13/233,294

(22) Filed: Sep. 15, 2011

(30) Foreign Application Priority Data
Mar. 16, 2011 (JP) 2011-057782

(51) Int. Cl. H04N 5/66

(52) U.S. Cl. 348/739; 348/E05.133

(57) ABSTRACT

According to one embodiment, a display has an indicator, an information extractor, and an indicator controller. The indicator is configured to irradiate first visible light indicative of an operation status of the display The information extractor is configured to extract at least a video signal and additional information from an input signal. The indicator controller is configured to modulate the first visible light with a frequency higher than a frame rate of the video signal according to the additional information.

### CROSS REFERENCE TO RELATED APPLICATIONS

This application is based upon and claims the benefit of priority from the prior Japanese Patent Application No. 2011-57782, filed on Mar. 16, 2011, the entire contents of which are incorporated herein by reference.

### FIELD

Embodiments described herein relate generally to a display, an information transmission method and an information communication system.

### BACKGROUND

A liquid crystal display has a liquid crystal panel composed by putting liquid crystal materials between a pair of glass substrates, and a backlight for irradiating light on the liquid crystal panel from back side thereof. Among the light irradiated from the backlight, light whose intensity depends on the orientation of the liquid crystal material passes through the liquid crystal material, and displayed on the liquid crystal display.

Conventionally, the light is always irradiated by the backlight on the liquid crystal panel. However, in recent year, a technique is used where the brightness of the backlight is adjusted according to the video signal in order to reduce the consumption power. For example, when the video signal shows black, the backlight may be turned off.

### BRIEF DESCRIPTION OF THE DRAWINGS

FIG. 1 is a schematic block diagram of an information communication system according to a first embodiment.

FIG. 2 is a flowchart showing an example of processing operations relating to the communication of the additional information in the information communication system of FIG. 1.

FIG. 3 is a schematic block diagram of the information communication system according to a second embodiment.

### DETAILED DESCRIPTION

In general, according to one embodiment, a display has an indicator, an information extractor, and an indicator controller. The indicator is configured to irradiate first visible light indicative of an operation status of the display The information extractor is configured to extract at least a video signal and additional information from an input signal. The indicator controller is configured to modulate the first visible light with a frequency higher than a frame rate of the video signal according to the additional information.

Embodiments will now be explained with reference to the accompanying drawings.

### First Embodiment

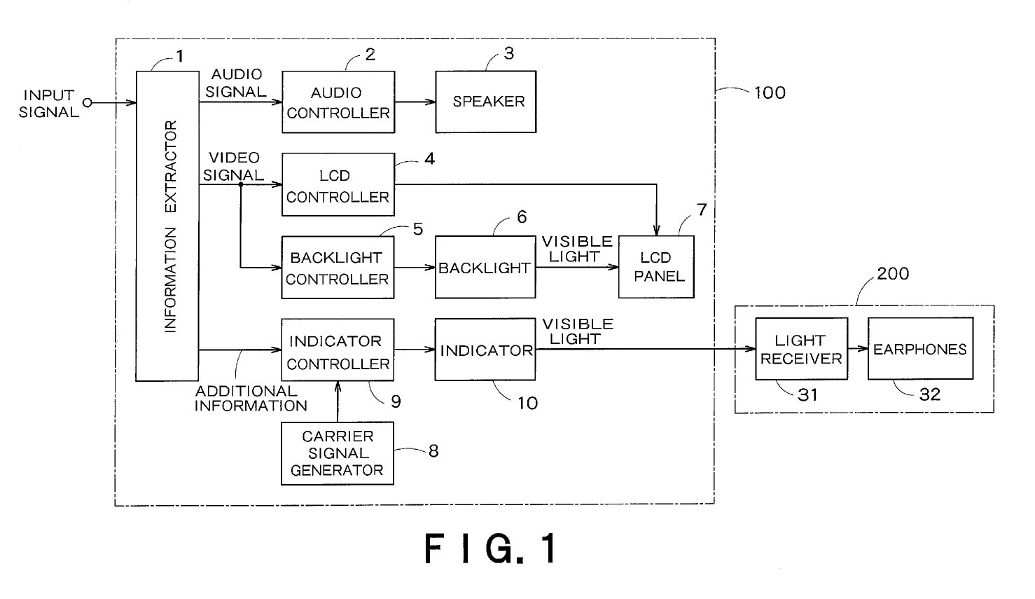

FIG. 1 is a schematic block diagram of an information communication system according to a first embodiment. The information communication system has a display 100 for transmitting information and a receiver 200 for receiving the information transmitted by the display 100.

The display 100 has an information extractor 1, an audio controller 2, a speaker 3, a liquid crystal controller (LCD controller) 4, a backlight controller 5, a backlight 6, a liquid crystal panel (LCD panel) 7, a carrier signal generator 8, an indicator controller 9 and an indicator 10.

The information extractor 1 extracts an audio signal and a video signal from an input signal inputted from outside such as a broadcast station or an optical disk reproducing apparatus. The audio controller 2 drives the speaker 3 according to the audio signal, and the speaker 3 reproduces the audio signal. Furthermore, the backlight controller 5 controls the backlight 6 according to the video signal. For example, when the video signal indicates dark images, the backlight controller 5 controls the backlight 6 so that the brightness of the backlight 6 becomes low. The liquid crystal controller 4 controls the orientation of the liquid crystal materials arranged in the liquid crystal panel 7 according to the video signal. By such a manner, among the visible light (second visible light) irradiated from the backlight 6, the light whose intensity depends on the video signal passes through the liquid crystal materials, and the images are displayed on the liquid crystal panel 7.

The frame rate of the video signal is, for example, 60 Hz. The liquid crystal controller 4 and the backlight controller 5 can control the liquid crystal panel 7 and the backlight 6 respectively with 60 Hz, or with 120 Hz or 240 Hz in order to improve the motion picture resolution by performing inter-frame interpolation. Here, the light source of the backlight 6 is, for example, an LED (Light Emitting Diode).

The information extractor 1 further extracts additional information. The additional information relates to the input signal and is, for example, a URL (Uniform Resource Locator) indicative of a homepage relevant to the video signal or an audio signal whose language is different from that of the audio signal extracted by the information extractor 1. In the present embodiment, an example is shown where the additional information is the audio signal.

The carrier signal generator 8 generates a carrier signal whose frequency is sufficiently higher than the frame rate, for example, 1 MHz. Although the frequency of the carrier signal may be one which human being cannot recognize, for example over 240 Hz, higher frequency is preferable in order to transmit and receive more information. The indicator controller 9 generates the emitting pattern of the indicator 10 by intensity-modulating the carrier signal according to the additional information.

The indicator 10 has at least one light source, and visible light (first visible light) irradiated by the light source indicates the operation status of the display 100. The indicator 10 can have multiple light sources and can indicate the statuses depending on the color. For example, when the indicator 10 irradiates green light, it indicates that the display 100 is in a status where the power of on, when it irradiates orange light, it indicates that the display 100 is in a status where the power is off although the power supply is distributed, and when it does not irradiate any light, it indicates that the display 100 is in a status where the power supply is not distributed.

Note that the display 100 can have further indicators indicating whether the audio signal is monaural signal or stereo signal, indicating whether or not the display 100 is receiving data broadcast and so on, in addition to the indicator indicative of the status of the power of the display 100. It is possible to use any indicators which are always lighting independent of the video signal.

Then, the indicator 10 irradiates light based on the operation status of the display 100 and the emitting pattern, generated by the indicator controller 9, on which the additional information is superimposed. The light source of the indicator 10 can repeat on and off with the frequency of the above mentioned carrier frequency, and is, for example, an LED. By using the LED, the additional information can be transmitted within a limited area because the LED has high directionality. Therefore, it is possible to prevent the additional information being transmitted toward the undesired wide area. Furthermore, since the visible light is not transmissive through the non-transparent object, there is little possibility that the additional information is transmitted to the neighboring rooms and so on through a wall.

Although the indicator 10 repeats on and off with the frequency of the carrier signal, human beings do not recognize the repeating because the frequency is high enough, and the indicator 10 is seen as continuously lighting. That is, the viewer recognizes only the operation status of the display 100.

On the other hand, the receiver 200 is arranged so that the receiver 200 can receive the visible light from the indicator 10. The receiver 200 has a light receiver 31 and earphones (additional information generator) 32. The light receiver 31 receives the visible light from the indicator 10 and decodes the additional information. Then, the audio signal is reproduced based on the decoded additional information.

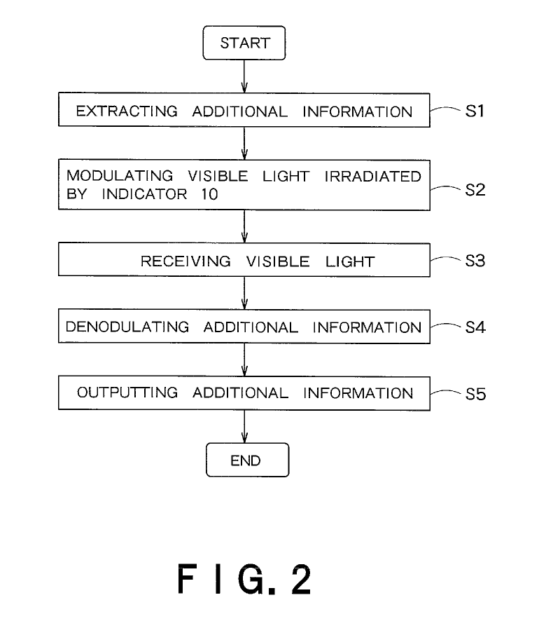

FIG. 2 is a flowchart showing an example of processing operations relating to the communication of the additional information in the information communication system of FIG. 1.

Firstly, the information extractor 1 of the display 100 extracts the additional information (in the present embodiment, the additional information is the audio signal whose language is different from that reproduced by the speaker 3) from the input signal (Step S1). Then, the indicator controller 9 generates the emitting pattern by modulating, according to the additional information, the carrier signal generated by the carrier signal generator 8. Based on the emitting pattern, the indicator 10 irradiates the visible light on which the additional information is superimposed (Step S2). For example, when the frequency of the carrier signal is 1 MHz, although the indicator 10 repeats turning on and off at 1 MHz, human beings do not recognize this. By such a manner, the additional information is transmitted from the display 100.

On the other hand, at the receiver 200 side, the light receiver 31 receives the visible light from the display 100 (Step S3), and demodulates it to obtain the audio signal (Step S4). Furthermore, the earphones 32 reproduce the audio signal (Step S5). Thus, the audio signal whose language is different from that reproduced by the speaker 3 can be heard.

An example has been explained where the additional information is an audio signal. However, when the additional information is, for example, an URL relating to the video signal, a personal computer connected to the internet is provided as an additional information generator, and a homepage indicated by the URL may be automatically displayed on the personal computer.

As stated above, in the first embodiment, the additional information is transmitted by superimposing it on the visible light irradiated by the indicator 10 provided in the display 100. Although the backlight 6 can be turned off according to the video signal, the indicator 10 always irradiates light. Therefore, the additional information can be transmitted to the outside regardless of the video signal. Furthermore, by using the indicator 10 having an LED as a light source, the LED can repeat turning on and off with high frequency. Therefore, the viewer does not recognize that the additional information is superimposed on the indicator. Additionally, since the LED has high directionality, the additional information can be transmitted within a limited area.

### Second Embodiment

In the first embodiment, the visible light irradiated by the indicator 10 is modulated according to the additional signal. On the other hand, in a second embodiment which will be described below, the light irradiated by the backlight 6 is also modulated according to the additional signal.

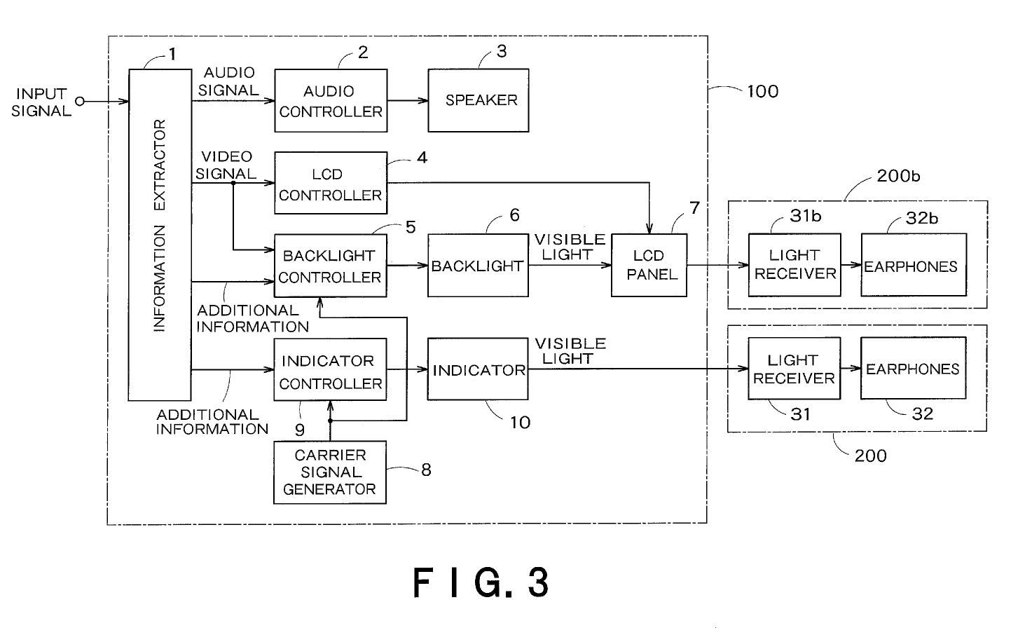

FIG. 3 is a schematic block diagram of the information communication system according to a second embodiment. In FIG. 3, components common to those of FIG. 1 have common reference numerals, respectively. Hereinafter, components different from FIG. 1 will be mainly described below.

The information extractor 1 extracts two kinds of additional information from the input signal, one of which is supplied to the backlight controller 5 (light source controller) and the other of which is supplied to the indicator controller 9. For example, the additional information supplied to the backlight controller 5 is an English audio signal, and the one supplied to the indicator controller 9 is a Chinese audio signal. The backlight controller 5 intensity-modulates the carrier signal according to the additional information to generate an emitting pattern of the backlight 6 (light source).

The backlight 6 irradiates light toward the liquid crystal panel (display module) 7 according to the video signal and the emitting pattern on which the additional information is superimposed. The backlight 6 is a light source capable of repeating turning on and off with the frequency of the carrier signal, and is, for example, an LED. Since the frequency of the carrier signal is much higher than the frame rate, the viewer does not recognize the pattern according to the additional information, and thus, the image displayed on the liquid crystal panel 7 is not seen disturbed.

The receiver 200a receives the visible light from the indicator 10 to reproduce the Chinese audio signal as well as the first embodiment. On the other hand, the receiver 200b receives the visible light from the liquid crystal panel 7. The light receiver 31b receives the visible light and demodulates the additional information which is the English audio signal. Then, the earphones 32b reproduce the English audio signal based on the demodulated additional information.

Here, each of the receiver 200a and the receiver 200b may receive both of the visible light from the liquid crystal panel 7 and that from the indicator 10. Therefore, the additional information can include a unique ID (identifying information). For example, the ID of the additional information supplied to the backlight controller 5 is set to be “1”, and the one supplied to the indicator controller 9 is set to be “2”. Then, the backlight controller 5 and the indicator controller 9 generate the emitting pattern including the IDs of the additional information to modulate the visible lights irradiated by the backlight 6 and by the indicator 10, respectively. The receivers 31a and 31b are, in advance, set the IDs of the additional information to be demodulated, and demodulate only one of the visible lights on which the corresponding ID is superimposed.

Furthermore, the backlight 6 can be divided into a plurality of areas, and it is possible to superimpose the additional information per the area, thereby transmitting more kinds of additional information. Also in this case, it is preferable that the IDs are assigned to each of the kinds of additional information. Note that the additional information supplied to the backlight controller 5 and that supplied to the indicator controller 9 can be the same information.

As stated above, in the second embodiment, more kinds of additional information can be transmitted because the additional information is superimposed also on the visible light irradiated by the backlight 6.

In another embodiment, 5.1 channel surround audio signal can be transmitted without wires. That is, one of rear speakers is the receiver 200a and the other is the receiver 200b, and the audio signals to be reproduced by the two rear speakers can be transmitted from the backlight controller 5 and the backlight 6, respectively.

Note that the light source of the indicator 10 and/or the backlight 6 can be a light source which can be controlled with a frequency higher than the frame late, for example, organic EL or inorganic EL can be used instead of the LED.

At least a part of the information communication system explained in the above embodiments can be formed of hardware or software. When the information communication system is partially formed of the software, it is possible to store a program implementing at least a partial function of the information transition system in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the information communication system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A display comprising:
an indicator configured to irradiate first visible light indicative of an operation status of the display;
an information extractor configured to extract at least a video signal and additional information from an input signal; and
an indicator controller configured to modulate the first visible light with a frequency higher than a frame rate of the video signal according to the additional information.

2. The display of claim 1, wherein the indicator is configured to irradiate the first visible light during receiving the input signal.

3. The display of claim 1 further comprising:
a light source configured to irradiate second visible light;
a light source controller configured to modulate the second visible light with a frequency higher than the frame rate of the video signal according to additional information extracted from the input signal; and
a display module configured to display the video signal by using at least a part of the modulated second visible light.

4. The display of claim 3, wherein the light source is an LED (Light Emitting Diode).

5. The display of claim 1, wherein the information extractor is configured to extract a plurality of kinds of additional information each comprising a unique identification information, and
the indicator controller is configured to modulate the first visible light in consideration of the identification information.

6. The display of claim 1, wherein the indicator comprises an LED configured to irradiate the first visible light.

7. The display of claim 1, wherein the indicator controller is configured to modulate the first visible light with the frequency which a viewer cannot recognize.

8. The display of claim 1, wherein the additional information is information indicative of a homepage with regard to the video signal.

9. The display of claim 1, wherein the information extractor is configured to extract a first audio signal of a first language from the input signal,
the additional information is a second audio signal of a second language different from the first language.

10. An information communication system comprising:
a display configured to transmit additional information; and
a receiver configured to receive the transmitted additional information;
wherein the display comprises:
an indicator configured to irradiate first visible light indicative of an operation status of the display;
an information extractor configured to extract at least a video signal and the additional information from an input signal; and
an indicator controller configured to modulate the first visible light with a frequency higher than a frame rate of the video signal according to the additional information,
wherein the receiver comprises:
a light receiver configured to receive the first visible light and obtain the additional information by demodulating the received visible first light; and
an additional information generator configured to output the additional information.

11. The system of claim 10, wherein the information extractor is configured to extract a plurality of kinds of additional information each comprising a unique identification information, and
the indicator controller is configured to modulate the first visible light in consideration of the identification information.

12. The system of claim 11, wherein the light receiver is configured to demodulate the first visible light on which predetermined identification information is superimposed.

13. The system of claim 10, wherein the indicator is configured to irradiate the first visible light during receiving the input signal.

14. The system of claim 10 further comprising:
a light source configured to irradiate second visible light;
a light source controller configured to modulate the second visible light with a frequency higher than the frame rate of the video signal according to additional information extracted from the input signal; and
a display module configured to display the video signal by using at least a part of the modulated second visible light.

15. The system of claim 10, wherein the light source is an LED (Light Emitting Diode).

16. The system of claim 10, wherein the indicator comprises an LED configured to irradiate the first visible light.

17. The system of claim 10, wherein the indicator controller is configured to modulate the first visible light with the frequency which a viewer cannot recognize.

18. The system of claim 10, wherein the additional information is information indicative of a homepage with regard to the video signal.

19. The system of claim 10, wherein the information extractor is configured to extract a first audio signal of a first language from the input signal,
the additional information is a second audio signal of a second language different from the first language, and
the additional information generator is configured to output the second audio signal.

20. An information transmission method using a display comprising an indicator indicative of an operation status of the display, comprising:
extracting at least a video signal and additional information from an input signal; and
modulating a first visible light irradiated by the indicator with a frequency higher than a frame rate of the video signal according to the additional information.
